(19) United States
(12) Patent Application Publication
(10) Pub. No.: US 2016/0109557 A1
(43) Pub. Date: Apr. 21, 2016

(54) SENSOR ARRAY MEASUREMENTS USING SELECT SENSOR PAIRS

(71) Applicant: THE BOEING COMPANY, Chicago, IL (US)

(72) Inventor: Kie L. Soohoo, Tustin, CA (US)

(21) Appl. No.: 14/515,431

(22) Filed: Oct. 15, 2014

(51) Int. Cl. G01S 5/22; G01S 5/06; G01S 5/16

(52) U.S. Cl. CPC G01S 5/22; G01S 5/16; G01S 5/06

(57) ABSTRACT

Apparatus and methods for using a sensor array to determine the position of a target object. An exemplary apparatus includes a sensor array having three or more sensors that each measures a distance to a target object in a coordinate system. The apparatus also includes a controller that identifies a first sensor pair (one or more) aligned along an axis that corresponds with a first coordinate axis, and processes measurements from the first sensor pair(s) to determine a first coordinate for the target object along the first coordinate axis. The controller also identifies a second sensor pair (one or more) aligned along an axis that corresponds with a second coordinate axis, and processes measurements from the second sensor pair(s) to determine a second coordinate for the target object along the second coordinate axis.

### GOVERNMENT LICENSE RIGHTS

This invention was made with United States Government (USG) support. The government has certain rights in the invention.

### FIELD

This disclosure relates to the field of sensor arrays, and more particularly, to measurements using sensor arrays.

### BACKGROUND

There are a variety of applications where it is desirable to use a positioning system to determine the two-dimensional (2D) or three-dimensional (3D) position of a target object, such as manufacturing, assembly, construction, etc. A positioning system may use an array of sensors that measure or determine a distance to the target object using time of flight or time difference of arrival measurements. The positioning system then determines an estimated position (e.g., x,y or x,y,z) of the target object in a coordinate system based on the measurements of the sensors. For example, a positioning system commonly takes measurements from all of the sensors in the array, and processes the measurements using a linear, multivariate least squares approach to determine the estimated position of the target object.

### SUMMARY

Embodiments described herein use measurements from select sensor pairs to determine individual coordinates for a target object instead of using measurements from all sensors in an array. A positioning system as described herein identifies sensor pairs that have an alignment toward one of the axes of the coordinate system. Measurements from these sensor pairs are used to estimate the position of the target object along that axis instead of considering measurements from all sensors in the array. For example, if a sensor pair has an alignment toward an x-axis of the coordinate system, then measurements from this sensor pair are used to estimate the position of the target object along the x-axis instead of considering measurements from all sensors in the array. If another sensor pair has an alignment in the direction toward a y-axis of the coordinate system, then measurements from this sensor pair are used to estimate the position of the target object along the y-axis instead of considering measurements from all sensors in the array. Because these sensor pairs are more aligned with one of the axes of the coordinate system, these sensor pairs may provide a more accurate measurement of the position of the target object along that axis. Therefore, the positioning system as described herein may provide more accurate position measurements as compared to a linear least square approach when there are calibration errors or variable calibration misalignments due to viewing geometry.

According to one embodiment, an apparatus includes a sensor array comprising three or more sensors each configured to measure a distance to a target object in a coordinate system having a first coordinate axis and a second coordinate axis. The apparatus also includes a controller comprising a first coordinate module and a second coordinate module. The first coordinate module is configured to identify one or more first sensor pairs aligned along an axis that corresponds with the first coordinate axis, and to process measurements from the first sensor pair(s) to determine a first coordinate for the target object along the first coordinate axis. The second coordinate module is configured to identify one or more second sensor pairs aligned along an axis that corresponds with the second coordinate axis, and to process measurements from the second sensor pair(s) to determine a second coordinate for the target object along the second coordinate axis.

Another embodiment comprises a method for operating a positioning system having a sensor array. The method includes measuring a distance to a target object with the sensor array comprising three or more sensors, where the target object is in a coordinate system having a first coordinate axis and a second coordinate axis. The method further includes identifying one or more first sensor pairs aligned along an axis that corresponds with the first coordinate axis, and processing measurements from the first sensor pair(s) to determine a first coordinate for the target object along the first coordinate axis. The method further includes identifying one or more second sensor pairs aligned along an axis that corresponds with the second coordinate axis, and processing measurements from the second sensor pair(s) to determine a second coordinate for the target object along the second coordinate axis.

Another embodiment comprises a positioning system configured to determine coordinates for a target object in a coordinate system. The positioning system includes a sensor array comprising three or more sensors each configured to measure a distance to the target object. The positioning system further includes a controller configured to identify one or more first sensor pairs aligned along an axis that relates more with a first coordinate axis of the coordinate system than a second coordinate axis, and to process measurements from the first sensor pair(s) only to determine a first coordinate for the target object along the first coordinate axis. The controller is further configured to identify one or more second sensor pairs aligned along an axis that relates more with the second coordinate axis of the coordinate system than the first coordinate axis, and to process measurements from the second sensor pair(s) only to determine a second coordinate for the target object along the second coordinate axis.

The features, functions, and advantages that have been discussed can be achieved independently in various embodiments or may be combined in yet other embodiments, further details of which can be seen with reference to the following description and drawings.

### DESCRIPTION OF THE DRAWINGS

Some embodiments of the present invention are now described, by way of example only, with reference to the accompanying drawings. The same reference number represents the same element or the same type of element on all drawings.

FIG. 1 illustrates a two-dimensional (2D) positioning system in an exemplary embodiment.

FIGS. 2-4 illustrate front views of a sensor array in an exemplary embodiment.

FIG. 5 illustrates a controller of a positioning system in an exemplary embodiment.

FIG. 6 is a flow chart illustrating a method for determining a position of a target object in an exemplary embodiment.

### DESCRIPTION

The figures and the following description illustrate specific exemplary embodiments. It will be appreciated that those skilled in the art will be able to devise various arrangements that, although not explicitly described or shown herein, embody the principles described herein and are included within the contemplated scope of the claims that follow this description. Furthermore, any examples described herein are intended to aid in understanding the principles of the disclosure, and are to be construed as being without limitation. As a result, this disclosure is not limited to the specific embodiments or examples described below, but by the claims and their equivalents.

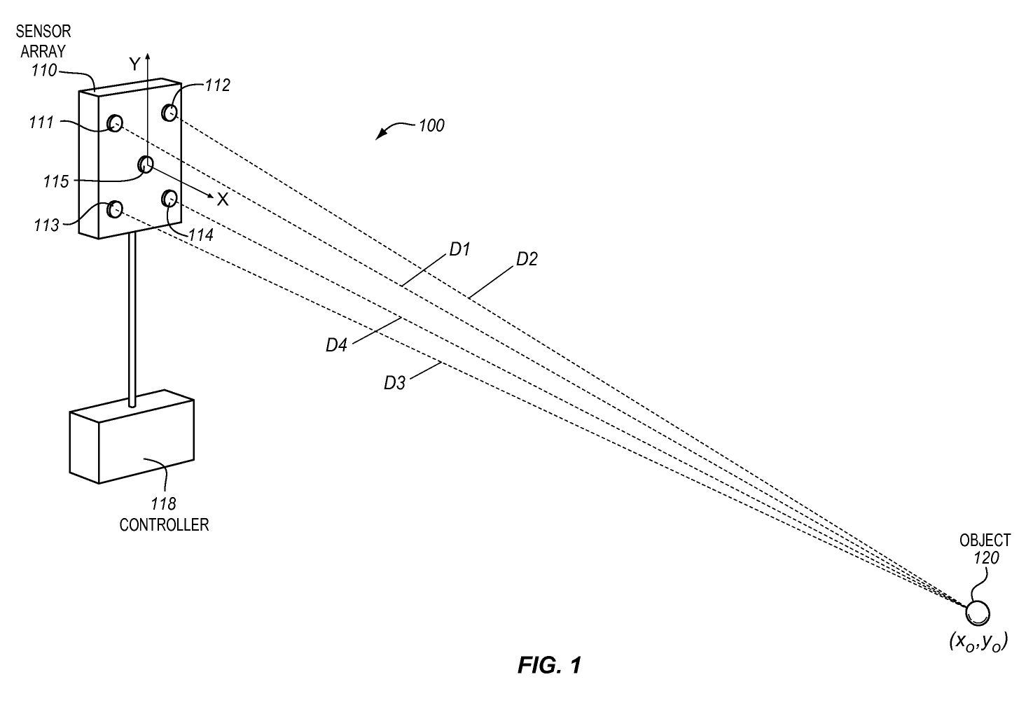

FIG. 1 illustrates a two-dimensional (2D) positioning system 100 in an exemplary embodiment. Positioning system 100 is configured to determine the position or location of one or more objects within a coordinate system. Positioning system 100 includes a sensor array 110 having a plurality of sensors 111-114. Sensors 111-114 comprise any component or module configured to measure a distance or a range to a target object 120. Sensors 111-114 may comprise acoustic sensors, electromagnetic sensors, laser sensors, or any other type of ranging sensor that uses, for example, time of flight or time of arrival measurements. Sensors 111-114 may operate in a pulse-echo mode or may receive a signal transmitted from object 120 for the time of flight and time of arrival measurements, respectively. Although four sensors 111-114 are shown in FIG. 1, there may be more or less sensors in array 110, but at a minimum there are three sensors in array 110 to determine a 2D position of object 120. Array 110 may also include a reference sensor 115 placed at the center of array 110. Measurements from reference sensor 115 may be used as a reference for time difference of flight or time difference of arrival measurements.

Positioning system 100 also includes a controller 118 that is in communication with sensor array 110. Controller 118 comprises any component or device that is able to process data from sensors 111-114 to determine a position or location of a target object within the coordinate system of the object. Controller 118 is connected to sensors 111-114 through some type of communication medium, such as a wired connection or wireless connection.

In this example, the coordinate system used in FIG. 1 is a Cartesian coordinate system having an x-axis (also referred to as a coordinate axis) and a y-axis. This type of coordinate system is just an example, as other types of coordinate systems may be implemented, such as polar coordinates (range, bearing).

For positioning system 100, sensors 111-114 are positioned with a clear line of sight to object 120. Each sensor 111-114 is configured to measure a distance to object 120, such as using time of flight and time of arrival measurements (e.g., distance=time*speed). The position of each sensor 111-114 is estimated within the coordinate system during calibration. Due to the position of each sensor 111-114 in the array 110, different pairs of sensors are better adapted to be used to determine the position or coordinate (xₒ,yₒ) of target object 120.

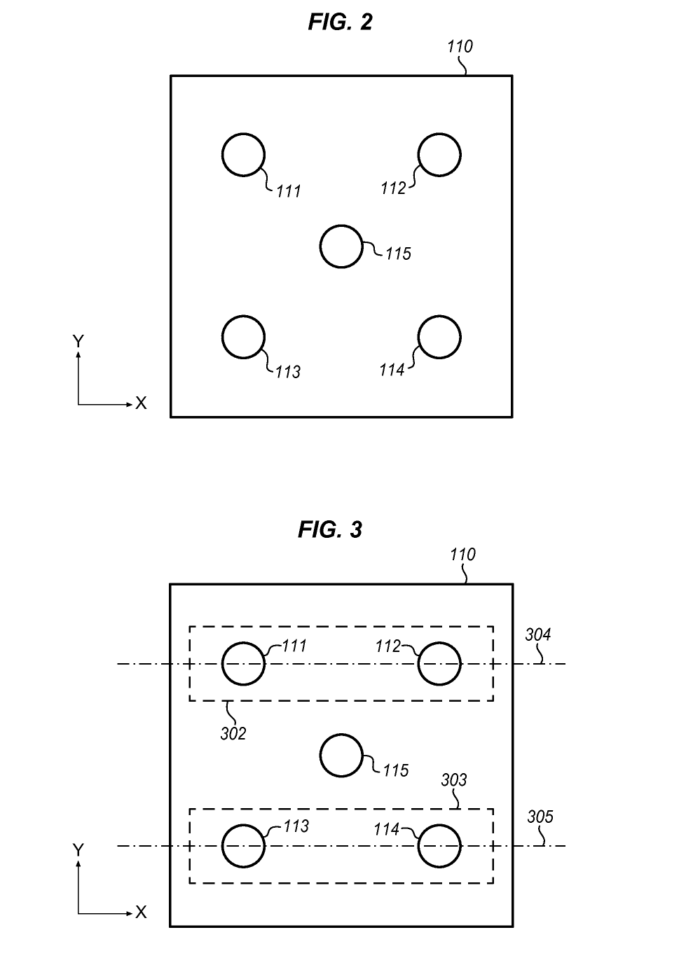

FIG. 2 illustrates a front view of sensor array 110 in an exemplary embodiment. Sensors 111-114 in array 110 have a rectangular configuration in this embodiment. Sensors 111 and 112 are positioned horizontally in relation to each other, as are sensors 113 and 114. Sensors 111 and 113 are positioned vertically in relation to each other, as are sensors 112 and 114.

Measurements from sensor array 110 may be taken in pairs of sensors. For instance, a measurement may be taken from sensors 111 and 112, a measurement may be taken from sensors 113 and 114, a measurement may be taken from sensors 111 and 113, a measurement may be taken from sensors 112 and 114, etc. A time of flight or time of arrival measurement may be taken by each sensor in the pair, and the difference between the measurements may be used to determine an estimated position of object 120 (see FIG. 1) in the coordinate system. Alternatively, a time of flight or time of arrival measurement may be taken by each sensor in the pair and reference sensor 115, and the difference between the measurements relative to reference sensor 115 may be used to determine an estimated position of object 120 (see FIG. 1) in the coordinate system.

Due to the configuration of sensor array 110, different sensor pairs are more aligned with one axis of the coordinate system than other sensor pairs. FIG. 3 illustrates another front view of sensor array 110 in an exemplary embodiment. As shown in FIG. 3, sensor pair 111 and 112 and sensor pair 113 and 114 (illustrated as boxes 302-303) are more aligned with the x-axis of the coordinate system than the y-axis. The arrangement or alignment of each sensor pair defines an axis. For example, the arrangement of sensor pair 111 and 112 defines an axis 304, and the arrangement of sensor pair 113 and 114 defines an axis 305. The axes 304-305 defined by the sensor pairs have a direction or orientation that are more aligned with the x-axis than the y-axis of the coordinate system.

FIG. 4 illustrates another front view of sensor array 110 in an exemplary embodiment. As shown in FIG. 4, sensor pair 111 and 113 and sensor pair 112 and 114 (illustrated as boxes 402-403) are more aligned with they-axis of the coordinate system than the x-axis. The arrangement of sensor pair 111 and 113 defines an axis 404, and the arrangement of sensor pair 112 and 114 defines an axis 405. The axes 404-405 defined by the sensor pairs are more aligned with the y-axis than the x-axis of the coordinate system.

Because sensor pairs in array 110 are more aligned with one axis than the other in the coordinate system, some sensor pairs can more accurately determine a position or coordinate (e.g., xₒ or yₒ) of object 120 in the coordinate system. For example, sensor pair 111 and 112 is more aligned with the x-axis of the coordinate system (see FIG. 3), so sensor pair 111 and 112 can more accurately determine the x-coordinate of object 120 than the y-coordinate. Similarly, sensor pair 111 and 113 is more aligned with the y-axis of the coordinate system (see FIG. 4), so sensor pair 111 and 113 can more accurately determine the y-coordinate of object 120 than the x-coordinate.

According to the embodiments described herein, measurements from sensor pairs that are more aligned with the x-axis are used to determine the x-coordinate for object 120. Measurements from other sensors pairs that are more aligned with the y-axis are ignored when determining the x-coordinate for object 120. Similar processing occurs for determining the y-coordinate, or even a z-coordinate in a three-dimensional (3D) coordinate system. Previously, measurements from all sensor pairs in a sensor array were processed (e.g., in a least squares fit algorithm) to determine coordinates for a target object. By focusing on measurements from sensor pairs that are more aligned with one axis than the other, the position of a target object may be determined more accurately.

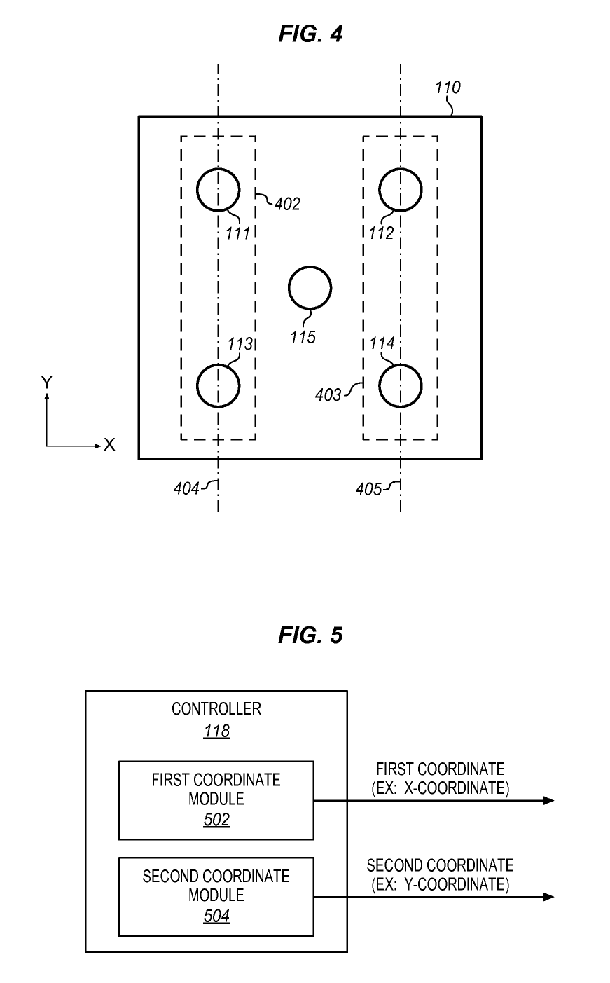

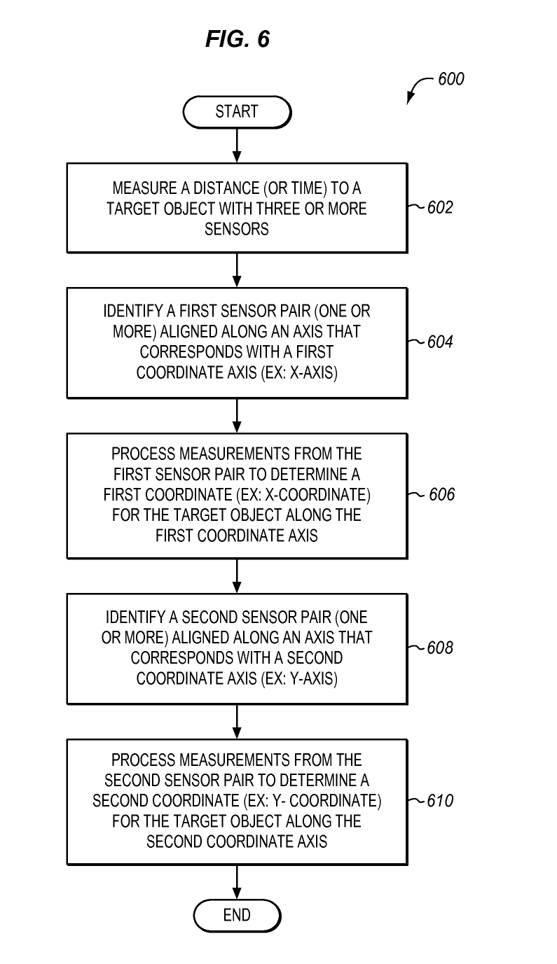

To implement the processing described above, controller 118 of positioning system 100 is enhanced in the present embodiment. FIG. 5 illustrates controller 118 in an exemplary embodiment. Controller 118 includes a first coordinate module 502 and a second coordinate module 504. First coordinate module 502 comprises a component or device (including hardware) that determines a first coordinate for a target object, but does not determine another coordinate for the target object. For example, first coordinate module 502 may determine an x-coordinate for the target object, but does not determine a y-coordinate for the target object. Second coordinate module 504 comprises a component or device (including hardware) that determines a second coordinate for a target object, but does not determine another coordinate for the target object. For example, second coordinate module 504 may determine a y-coordinate for the target object, but does not determine an x-coordinate for the target object. The determinations in coordinate modules 502 and 504 are exclusive to one another based on data from sensor pairs. The operation of coordinate modules 502 and 504 are described in more detail in FIG. 6.

FIG. 6 is a flow chart illustrating a method 600 for determining a position of a target object in an exemplary embodiment. The steps of method 600 will be described with respect to positioning system 100 of FIG. 1 and controller 118 in FIG. 5, although one skilled in the art will understand that the methods described herein may be performed by other devices or systems not shown. The steps of the methods described herein are not all inclusive and may include other steps not shown. The steps for the flow charts shown herein may also be performed in an alternative order.

To begin, each sensor 111-114 measures a distance (or time) to object 120 (step 602). As shown in FIG. 1, sensor 111 may measure a distance D1, sensor 112 may measure a distance D2, sensor 113 may measure a distance D3, and sensor 112 may measure a distance D4. Sensors 111-114 then provide signals or data to controller 118 which represents the distance measurements.

First coordinate module 502 identifies one or more sensor pairs aligned along an axis that corresponds with a first coordinate axis (step 604). For example, if the first coordinate axis is the x-axis, then first coordinate module 502 can identify sensor pair 111 and 112 and sensor pair 113 and 114 as aligned along axes that correspond with the x-axis (see FIG. 3). The axis of a sensor pair “corresponds with” a first coordinate axis when the axis of the sensor pair relates more with (i.e., is more aligned with) the first coordinate axis than another coordinate axis. For example, the axis 304 of sensor pair 111 and 112 is aligned (substantially parallel) with the x-axis in FIG. 3 and is perpendicular to they-axis, so axis 304 “corresponds with” the x-axis as opposed to they-axis.

The sensors 111-114 in array 110 are arranged in a square or rectangular pattern making the axes of the sensor pairs either vertical or horizontal as illustrated in FIGS. 2-4. However, sensor array 110 may have different sensor configurations where the axes of the sensor pairs are not parallel with any one of the coordinate axis. In these instances, an axis of a sensor pair corresponds with a coordinate axis when it is more aligned with (i.e., has a smaller angle with) the coordinate axis than with any other coordinate axis.

First coordinate module 502 processes measurements from the identified sensor pair(s) to determine a first coordinate for target object 120 along the first coordinate axis (step 606). For example, if first coordinate module 502 identifies sensor pair 111 and 112 and sensor pair 113 and 114 as corresponding with the x-axis, then first coordinate module 502 processes measurements from these sensor pairs to determine the x-coordinate for target object 120. First coordinate module 502 may process the measurements exclusively from these sensor pairs, and may ignore measurements from other sensor pairs. For example, first coordinate module 502 may identify that sensor pair 111 and 113 and sensor pair 112 and 114 correspond with the y-axis, so first coordinate module 502 may ignore measurements from these sensor pairs in determining the x-coordinate for target object 120.

First coordinate module 502 may use a matrix equation to determine the first coordinate for object 120. The equation takes into account the distance (or time) measurements from sensor pairs found to be aligned (substantially) with the coordinate axis, and the position of sensors in the coordinate system. An exemplary matrix equation which may be used is a follows:

AX=B, (1)
where A is the matrix of the sensor positions (i.e., calibrated sensor coordinates), X is the estimated position of object 120, and B is a function of the time of arrival measurements from the sensor pairs or time difference of arrival measurements relative to reference sensor 115.

Similarly, second coordinate module 504 identifies one or more sensor pairs aligned along an axis that corresponds with a second coordinate axis (step 608). For example, if the second coordinate axis is they-axis, then second coordinate module 504 can identify sensor pair 111 and 113 and sensor pair 112 and 114 as defining axes that correspond with the y-axis (see FIG. 4). As above, the axis of a sensor pair “corresponds with” a second coordinate axis, when the axis of the sensor pair relates more (i.e., is more aligned) with the second coordinate axis than another coordinate axis. For example, the axis 404 of sensor pair 111 and 113 is aligned (substantially parallel) with the y-axis in FIG. 4 and is perpendicular to the x-axis, so axis 404 corresponds with the y-axis as opposed to the x-axis.

Second coordinate module 504 processes measurements from the identified sensor pair(s) to determine a second coordinate for target object 120 along the second coordinate axis (step 610). For example, if second coordinate module 504 identifies sensor pair 111 and 113 and sensor pair 112 and 114 as corresponding with they-axis, then second coordinate module 504 processes measurements from these sensor pairs to determine the y-coordinate for target object 120. Second coordinate module 504 may process the measurements exclusively from these sensor pairs, and may ignore measurements from other sensor pairs. For example, second coordinate module 504 may identify that sensor pair 111 and 112 and sensor pair 113 and 114 correspond with the x-axis, so second coordinate module 504 may ignore measurements from these sensor pairs in determining they-coordinate for target object 120.

First coordinate module 502 therefore determines a first coordinate for object 120 (e.g., xₒ), and second coordinate module 504 determines a second coordinate for object 120 (e.g., yₒ). Controller 118 then yields the 2D position of object 120, such as (xₒ,yₒ).

Because method 600 determines individual coordinates for object 120 by using sensor pairs that selected based on their orientation with the coordinate axes, the data used to determine the individual coordinates is more accurate. Thus, method 600 may provide a more accurate estimate of the position (xₒ,yₒ) of object 120 within the coordinate system.

A similar method may be used to determine a 3D position of object 120. To determine a 3D position of object 120, at least four sensors are arranged in a 3D rectangular array instead of a planar array as shown in FIG. 1.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope is not limited to those specific embodiments. Rather, the scope is defined by the following claims and any equivalents thereof.

1. An apparatus comprising:
a sensor array comprising at least three sensors each configured to measure a distance to a target object in a coordinate system having a first coordinate axis and a second coordinate axis; and
a controller comprising:
a first coordinate module configured to identify at least one first sensor pair aligned along an axis that corresponds with the first coordinate axis, and to process measurements from the at least one first sensor pair to determine a first coordinate for the target object along the first coordinate axis; and
a second coordinate module configured to identify at least one second sensor pair aligned along an axis that corresponds with the second coordinate axis, and to process measurements from the at least one second sensor pair to determine a second coordinate for the target object along the second coordinate axis.

2. The apparatus of claim 1 wherein:
the first coordinate module is configured to identify that the axis defined by the at least one first sensor pair relates more with the first coordinate axis than the second coordinate axis; and
the second coordinate module is configured to identify that the axis defined by the at least one second sensor pair relates more with the second coordinate axis than the first coordinate axis.

3. The apparatus of claim 1 wherein:
the coordinate system comprises a Cartesian coordinate system;
the first coordinate module is configured to determine an x-coordinate for the target object along an x-axis; and
the second coordinate module is configured to determine a y-coordinate for the target object along a y-axis.

4. The apparatus of claim 3 wherein:
the sensor array comprises four sensors having a rectangular configuration;
the first coordinate module is configured to identify sensors in the array that are positioned horizontally in relation to each other as the at least one first sensor pair, and to determine the x-coordinate for the target object along the x-axis exclusively from the measurements of the at least one first sensor pair;
the second coordinate module is configured to identify sensors in the array that are positioned vertically in relation to each other as the at least one second sensor pair, and to determine the y-coordinate for the target object along the y-axis exclusively from the measurements of the at least one second sensor pair.

5. The apparatus of claim 4 wherein:
the first coordinate module is configured to ignore measurements from the at least one second sensor pair when determining the x-coordinate for the target object along the x-axis; and
the second coordinate module is configured to ignore measurements from the at least one first sensor pair when determining the y-coordinate for the target object along the y-axis.

6. The apparatus of claim 1 wherein:
the sensors comprise acoustic sensors.

7. The apparatus of claim 1 wherein:
the sensor array further includes a reference sensor.

8. A method of operating a positioning system having a sensor array, the method comprising:
measuring a distance to a target object with the sensor array comprising at least three sensors, wherein the target object is in a coordinate system having a first coordinate axis and a second coordinate axis;
identifying at least one first sensor pair aligned along an axis that corresponds with the first coordinate axis;
processing measurements from the at least one first sensor pair to determine a first coordinate for the target object along the first coordinate axis;
identifying at least one second sensor pair aligned along an axis that corresponds with the second coordinate axis; and
processing measurements from the at least one second sensor pair to determine a second coordinate for the target object along the second coordinate axis.

9. The method of claim 8 wherein identifying at least one first sensor pair aligned along an axis that corresponds with the first coordinate axis comprises:
identifying that the axis of the at least one first sensor pair relates more with the first coordinate axis than the second coordinate axis.

10. The method of claim 9 wherein identifying at least one second sensor pair aligned along an axis that corresponds with the second coordinate axis comprises:
identifying that the axis of the at least one second sensor pair relates more with the second coordinate axis than the first coordinate axis.

11. The method of claim 8 wherein:
processing measurements from the at least one first sensor pair to determine the first coordinate for the target object along the first coordinate axis comprises determining an x-coordinate for the target object along an x-axis in a Cartesian coordinate system; and
processing measurements from the at least one second sensor pair to determine the second coordinate for the target object along the second coordinate axis comprises determining a y-coordinate for the target object along a y-axis in the Cartesian coordinate system.

12. The method of claim 11 wherein determining the x-coordinate for the target object comprises:
determining the x-coordinate for the target object along the x-axis exclusively from the measurements of the at least one first sensor pair.

13. The method of claim 12 wherein determining the x-coordinate for the target object along the x-axis exclusively from the measurements of the first sensor pair comprises:
ignoring measurements from the at least one second sensor pair when determining the x-coordinate for the target object along the x-axis.

14. The method of claim 11 wherein determining the y-coordinate for the target object comprises:
determining they-coordinate for the target object along they-axis exclusively from the measurements of the at least one second sensor pair.

15. The method of claim 14 wherein determining the y-coordinate for the target object along the y-axis exclusively from the measurements of the second sensor pair comprises:
ignoring measurements from the at least one first sensor pair when determining the y-coordinate for the target object along they-axis.

16. A positioning system configured to determine coordinates for a target object in a coordinate system, the positioning system comprising:
a sensor array comprising at least three sensors each configured to measure a distance to the target object; and
a controller configured to identify at least one first sensor pair aligned along an axis that relates more with a first coordinate axis of the coordinate system than a second coordinate axis, and to process measurements from the at least one first sensor pair only to determine a first coordinate for the target object along the first coordinate axis;
the controller configured to identify at least one second sensor pair aligned along an axis that relates more with the second coordinate axis than the first coordinate axis, and to process measurements from the at least one second sensor pair only to determine a second coordinate for the target object along the second coordinate axis.

17. The positioning system of claim 16 wherein:
the coordinate system comprises a Cartesian coordinate system;
the controller is configured to determine an x-coordinate for the target object along an x-axis only from the measurements from the at least one first sensor pair; and
the controller is configured to determine a y-coordinate for the target object along a y-axis only from the measurements from the at least one second sensor pair.

18. The positioning system of claim 17 wherein:
the controller includes:
a first coordinate module configured to determine the x-coordinate for the target object along the x-axis; and
a second coordinate module configured to determine the y-coordinate for the target object along the y-axis.

19. The positioning system of claim 16 wherein:
the sensor array further includes a reference sensor.

20. The positioning system of claim 19 wherein:
the reference sensor is positioned at the center of the sensor array.
